(19) United States
(12) Patent Application Publication
(10) Pub. No.: US 2021/0309149 A1
(43) Pub. Date: Oct. 7, 2021

(54) DRIVING SUPPORT DEVICE AND DRIVING SUPPORT METHOD

(71) Applicant: NEC Corporation, Minato-ku, Tokyo (JP)

(72) Inventor: Kazuki INAGAKI, Tokyo (JP)

(73) Assignee: NEC Corporation, Minato-ku, Tokyo (JP)

(21) Appl. No.: 17/261,424

(22) PCT Filed: Jul. 24, 2019
(86) PCT No.: PCT/JP2019/028984

§ 371 Date: Jan. 19, 2021

(30) Foreign Application Priority Data
Jul. 26, 2018 (JP) 2018-140768

(51) Int. Cl. B60R 1/00; G06T 11/20; H04N 7/18; G06T 5/00; G08G 1/16

(52) U.S. Cl. CPC B60R 1/00; G06T 11/203; H04N 7/18; B60R 2300/308; G08G 1/16; G06T 2207/30248; G06T 5/006

(57) ABSTRACT

A driving support device is configured to acquire a captured image from an imaging device configured to capture an image in surrounding of a moving body and to generate an instruction image based on the captured image such that a position of a predetermined portion of the moving body is fitted to a position of a reference line in the captured image. A driver may accurately grasp the position relationship between a moving body (e.g. a vehicle) and an obstacle with reference to the instruction image.

### TECHNICAL FIELD

The present invention relates to a driving support device and a driving support method.

### BACKGROUND ART

Technology for displaying captured images of cameras attached to moving bodies on display devices (e.g. monitors) have been known. For example, a driving support device is designed to output the captured image of a camera mounted on a vehicle to a monitor mounted inside of a vehicle. Using the driving support device configured to output images outside a vehicle (e.g. images of roads, attachments, obstacles, pedestrians or the like) to a monitor, a driver may drive a vehicle by watching images not only in the traveling direction of a vehicle but also in the rear direction of a vehicle so as to detect any risks at driving (or any events causing obstacles to driving).

Patent Document 1 discloses a driving support device of a vehicle. The driving support device is designed to detect a steering angle of a vehicle, to calculate a traveling prediction curve in an image captured in a traveling direction of a vehicle, to generate a rectangle plane for each predetermined distance perpendicular to the ground according to the height of a vehicle, and to display the rectangular plane along the traveling-prediction curve. A driver may recognize the position of an obstacle and the height of a vehicle relative to the obstacle with reference to rectangular planes displayed along the traveling-prediction curve.

Patent Document 2 discloses an image processing device designed to carry out a normalization process and distortion corrections to fisheye images reflecting target objects. For example, fisheye images are captured by a fisheye camera attached to the rear side of a vehicle and displayed on a rearview monitor.

Non-Patent Document 1 discloses a correction method of images captured by an omnidirectional camera.

### CITATION LIST

### Patent Literature Document

Patent Document 1: Japanese Patent No. 4350838
Patent Document 2: Japanese Patent No. 6330987

### Non-Patent Literature Document

Non-Patent Document 1: Davide Scaramuzza, Agostino Martinelli, Roland Siegwart, “A Toolbox for Easily Calibrating Omnidirectional Cameras”, IROS 2006

### SUMMARY OF INVENTION

### Technical Problem

For the benefit of a driver to obtain a wide view with respect to the position relationship between an obstacle and a vehicle in traveling, it is possible to use a camera equipped with a fisheye lens having a wide angle of view. However, a fisheye image captured by a camera having a fisheye lens may be distorted in an image-capturing manner, and therefore it is difficult to grasp the position relationship between an obstacle and a vehicle (or a moving body). For this reason, it is demanded to develop a technology by which a driver may accurately grasp the position relationship between an obstacle and a vehicle when capturing images outside a vehicle with a camera having a fisheye lens attached to the vehicle.

The present invention is made in consideration of the aforementioned problem and aims to provide a driving support device and a driving support method, which are each configured to support a driver's operation to drive a vehicle by accurately capturing and outputting images outside a moving body (e.g. a vehicle).

### Solution to Problem

In a first aspect of the present invention, a driving support device includes a captured-image acquisition part configured to acquire a captured image from an imaging device configured to capture an image in surrounding of a moving body, and an instruction image generation part configured to generate an instruction image based on the captured image such that a position of a predetermined portion of the moving body is fitted to a position of a reference line in the captured image.

In a second aspect of the present invention, a driving support method implements the steps of: acquiring a captured image from an imaging device configured to capture an image in surrounding of a moving body, and generating an instruction image based on the captured image such that a position of a predetermined portion of the moving body is fitted to a position of a reference line in the captured image.

In a third aspect of the present invention, a storage medium stores a program causing a computer to implement the steps of: acquiring a captured image from an imaging device configured to capture an image in surrounding of a moving body, and generating an instruction image based on the captured image such that a position of a predetermined portion of the moving body is fitted to a position of a reference line in the captured image.

### Advantageous Effects of Invention

According to the present invention, it is possible to generate images by which a driver is able to accurately grasp the position relationship between an obstacle and a moving body (e.g. a vehicle).

### BRIEF DESCRIPTION OF DRAWINGS

FIG. 1 is a schematic diagram showing a moving body (or a vehicle) having a driving support device according to one exemplary embodiment of the present invention.

FIG. 2 is a schematic diagram showing the connection relationship between a camera and the driving support device according to one exemplary embodiment of the present invention.

FIG. 3 is a block diagram showing a hardware configuration of the driving support device according to one exemplary embodiment of the present invention.

FIG. 4 is a block diagram showing functional parts of the driving support device according to one exemplary embodiment of the present invention.

FIG. 5 is an image diagram showing examples of instruction images corresponding to fisheye images captured by a camera.

FIG. 6 is a flowchart showing a procedure of processing of the driving support device according to one exemplary embodiment of the present invention.

FIG. 7 is a schematic diagram showing the definition of a coordinates system of a camera connected to the driving support device according to one exemplary embodiment of the present invention.

FIG. 8 is an explanatory diagram for explaining viewpoint compensation vectors expressed using roll-pitch-yaw expression with respect to rotation of a camera.

FIG. 9 is an explanatory diagram for explaining transformation of coordinates between two viewpoints with respect to rotation of a camera.

FIG. 10 is an explanatory diagram for explaining a coordinates system in an original viewpoint and a horizontalized viewpoint coordinates system with respect to rotation of a camera.

FIG. 11 is an image diagram showing an example of a fisheye image (I_{F}) subjected to an image generation process.

FIG. 12 is a coordinates diagram showing an example of a horizontalized viewpoint coordinate system defined in the image generation process.

FIG. 13 is an image diagram showing two perspective-projection-corrected images in different horizontalized viewpoints and a normalized panoramic image obtained from perspective-projection-corrected images.

FIG. 14 is a flowchart showing the image generation process.

FIG. 15 is a block diagram showing a minimum configuration of the driving support device according to one exemplary embodiment of the present invention.

### DESCRIPTION OF EXEMPLARY EMBODIMENTS

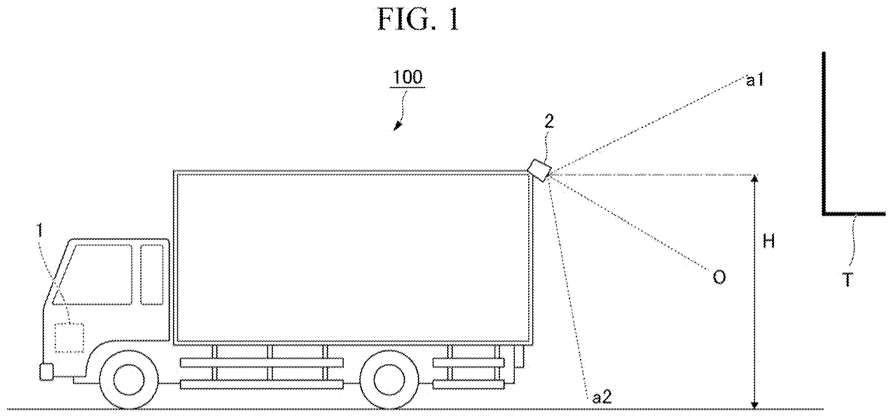

A driving support device and a driving support method according to the present invention will be described in detail by way of exemplary embodiments with reference to the accompanying drawings. FIG. 1 is a schematic diagram showing a moving body (e.g. a vehicle) 100 mounting a driving support device 1 thereon according to one exemplary embodiment of the present invention. For example, the moving body 100 is a truck equipped with a camera at the rear-top position thereof. The camera 2 having a fisheye lens is configured to capture fisheye images converged in its angle of view within a conical range including a conical plane defined by an axis representing an upper-imaging-range boundary a1 and another axis representing a lower-imaging-range boundary a2. In FIG. 1, a symbol “O” shows an optical axis of the camera 2. In FIG. 1, a symbol “T” shows an obstacle existing in the rear side of the moving body (e.g. a truck) 100. The height of the installed position of the camera 2 relative to the ground corresponds to a height H of the rear-top position of a carriage of the moving body 100. The camera 2 is not necessarily disposed at the rear-top position of a carriage of the moving body 100. When the camera 2 is not disposed at the rear-top position of a carriage of the moving body 100, it is necessary to transform the height of the actually-installed position of the camera relative to the ground into the height H of the rear-top position of a carriage of the moving body 100 when generating instruction images which will be described later.

The moving body 100 is equipped with the driving support device 1 in a driver's seat side. The driving support device 1 and the camera 2 are wireless connected together or connected together using wires. The camera 2 is configured to transit fisheye images captured in the rear side of the moving body 100 to the driving support device 1. For example, the driving support device 1 is a car navigation device. A fisheye image of the camera 2 is transformed to generate an instruction image, which is output to a monitor. In this connection, instruction images generated by the driving support device 1 will be described later. Upon viewing an instruction image which is captured when the moving body 100 moves in a rear direction, a driver may recognize the position relationship in a height direction between the uppermost position of the moving body 100 and the obstacle T located in the rear-top direction from the moving body 100.

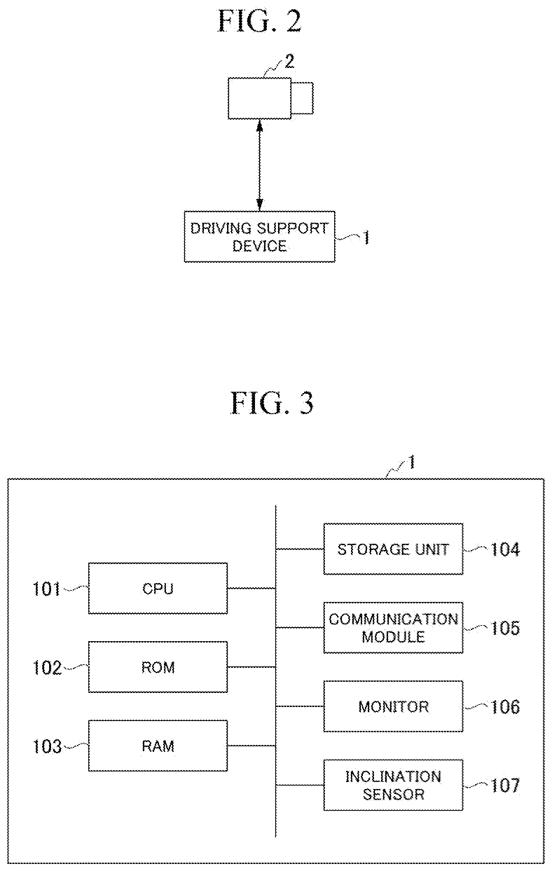

FIG. 2 is a schematic diagram showing the connection relationship between the driving support device 1 and the camera 2. FIG. 3 is a block diagram showing a hardware configuration of the driving support device 1. The driving support device 1 is configured to communicate with the camera 2. The driving support device 1 is an information processing device (or a computer) having hardware elements such as a CPU (Central Processing Unit) 101, a ROM (Read-Only Memory) 102, a RAM (Random-Access Memory), a storage unit 104, a communication module 105, a monitor 106, and an inclination sensor (or an angle sensor) 107. The inclination sensor 107 is configured to detect an inclination of the moving body 100.

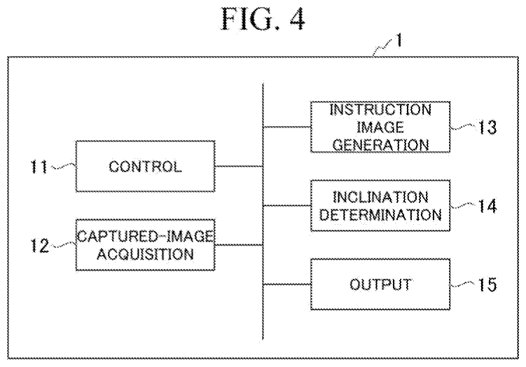

FIG. 4 is a block diagram showing functional parts of the driving support device 1. Upon turning on power, the driving support device 1 starts its operation to execute a driving-assistant program stored in advance, thus realizing various functional parts. Specifically, the driving support device 1 includes a control part 11, a captured-image acquisition part 12, an instruction-image generation part 13, an inclination determination part 14, and an output part 15.

The control part 11 is configured to control the functional parts 12 through 15 of the driving support device 1. The captured-image acquisition part 12 is configured to acquire a fisheye image from the camera 2 attached to the rear-top position of the moving body 100. The instruction-image generation part 13 is configured to generate an instruction image based on a captured image. The instruction image is generated by matching the rear-top position of the moving body 100 with a reference position of the captured image. In this connection, a method for generating instruction images will be described later. The inclination determination part 14 is configured to determine an inclination of the moving body 100 based on the inclination information obtained from the inclination sensor 107. The output part 15 is configured to output instruction images to the monitor 106 of the driving support device 1.

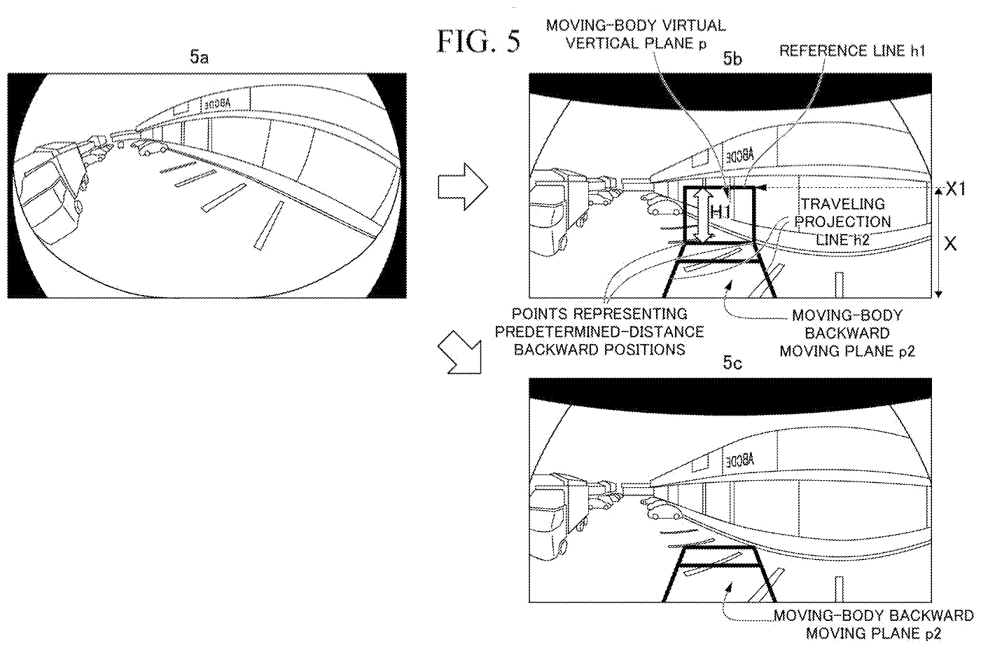

FIG. 5 is an image diagram showing instruction images 5b, 5c in correspondence with a fisheye image 5a captured by the camera 2. In FIG. 5, the fisheye image 5a is shown in the left side; the first instruction image 5b is shown in the upper-right side; the second instruction image 5c is shown in the lower-right side. The driving support device 1 is configured to capture the fisheye image 5a from the camera 2, to transform the fisheye image 5a into the first instruction image 5b by way of distortion corrections, and to output the first instruction image 5b to the monitor 106. The first instruction image 5b is generated relative to a horizontal position X1 serving as a reference position. In the first instruction image 5b, the position of a reference line (i.e. a reference line at a position equivalent to the uppermost position of the moving body 100) h1 corresponding to a distance H1 above the ground which may be equivalent to the height H of the moving body 100 is fitted to the horizontal reference position X1. The horizontal reference position X1 is set to the position distanced by X above the lowermost position of the first instruction image 5b. The first instruction image 5b includes at least a moving-body virtual vertical plane p having a rectangular shape whose one side matches the reference line h1 equivalent to the uppermost position of the moving body 100 at the horizontal reference position H1. Specifically, the instruction-image generation part 13 of the driving support device 1 is configured to generate the first instruction image 5b including two traveling prediction lines h2 extended by a predetermined distance backwardly from the moving body 100 at the positions along the opposite-side faces of the moving body 100 in the captured image after distortion corrections. In addition, the instruction-image generation part 13 is configured to form a moving-body virtual vertical plane p using a line connected between distal points at a predetermined distance backward from the moving body 100, two vertical lines having the height H1 which are originated from those points, and the reference line h1 (i.e. a reference line equivalent to the uppermost position of the moving body 100) in addition to two traveling prediction lines h2 in the captured image after distortion corrections. In addition, it is possible to form a moving-body backward moving plane p2 having a rectangular shape using the two traveling prediction lines h2 and the line connected between the distal points at a predetermined distance backward from the moving body 100. Subsequently, the driving support device 1 may output the first instruction image 5b including the moving-body virtual vertical plane p and the moving-body backward moving plane p2. Accordingly, a driver may determine the existence/nonexistence of any contact with obstacles at the predetermined-distance backward positions from the uppermost position and the side faces of the moving body 100. In the present exemplary embodiment, the reference horizontal position X1 is set to the center position of the first instruction image 5b in its vertical direction. In this connection, the reference horizontal position X1 is not necessarily set to the center position of the first instruction image 5b in its vertical direction but can be set to a predetermined position of the first instruction image 5b in its vertical direction.

When the inclination of the moving body 100 is equal to or above a predetermined inclination, the driving support device 1 may generate the second instruction image 5c by precluding the moving-body virtual vertical plane p from the first instruction image 5b.

It is possible to detect an obstacle using a sonar or an acoustic sensor attached to the upper-rear position of a carriage of the moving body 100. In this case, it is possible to change a display manner of instruction images upon detecting an obstacle with a sonar. For example, it is possible to enhance the reference line h1 displayed in the first instruction image 5b by changing colors or flashing the reference line h1 equivalent to the uppermost position of the moving body 100. Alternatively, it is possible to concurrently give a warning notice using a sonar such as alarm sound to be produced when the moving body 100 moves backwards. Accordingly, it is possible to notify a driver of a possibility of collision with an obstacle due to the height of the moving body 100.

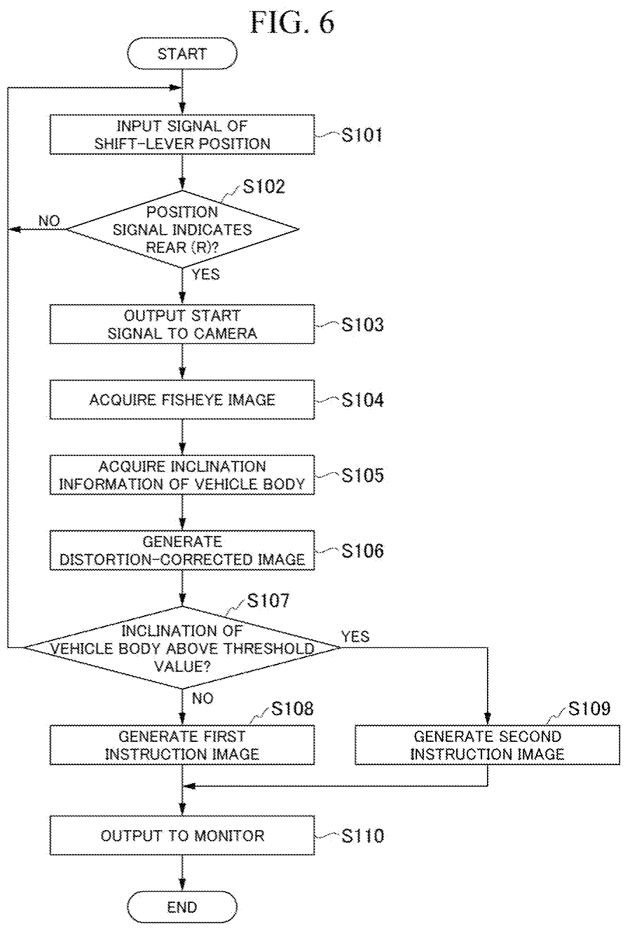

FIG. 6 is a flowchart showing a procedure of processing implemented by the driving support device 1. Next, the procedure of processing of the driving support device 1 (steps S101 through S110) will be described below.

The driving support device 1 starts its operation interlocked with the startup of the moving body 100. The driving support device 1 may input signals from various types of sensors installed in the moving body 100. For example, the driving support device 1 inputs a signal relating to the position of a shift lever of the moving body (e.g. a vehicle) 100 (S101). The control part 11 of the driving support device 1 determines whether or not a position signal of the shift lever of the moving body 100 indicates a rear (R) (S102). When the position signal of the shift lever indicates the rear (R), the control part 11 outputs a start signal to the camera 2 (S103). The camera 2 starts its operation according to the start signal. When started, the camera 2 starts an imaging operation to capture an image (e.g. a fisheye image) so as to transmit the captured image to the driving support device 1.

The captured-image acquisition part 12 of the driving support device 1 acquires the fisheye image from the camera 2 (S104). The inclination determination part 14 of the driving support device 1 acquires the inclination information of the moving body (e.g. a vehicle) 100 from the inclination sensor 107 (S105). Subsequently, the instruction image generation part 13 acquires the fisheye image via the captured-image acquisition part 12. The instruction image generation part 13 corrects distortions of the fisheye image so as to generate a distortion-corrected image (S106). As a process for generating a distortion-corrected image from the captured image, it is possible to use a known technology. The details of the process for generating a distortion-corrected image according to the present exemplary embodiment will be described later.

The inclination determination part 14 determines whether or not the inclination of the moving body 100 obtained from the inclination sensor 107 is equal to or above a predetermined threshold value (S107). The inclination determination part 14 outputs to the instruction image generation part 13 a determination result as to whether or not the inclination of the moving body 100 is equal to or above a predetermined inclination (e.g. five degrees). When the inclination of the moving body 100 is less than the predetermined threshold value, the instruction image generation part 13 determines to generate the first instruction image 5b. When the inclination of the moving body 100 is equal to or above the predetermined threshold value, the instruction image generation part 13 determines to generate the second instruction image 5c.

When the inclination of the moving body 100 is less than the predetermined threshold value, the instruction image generation part 13 generates the first instruction image 5b (S108). The first instruction image 5b includes the moving-body virtual vertical plane p having a rectangular shape whose one side corresponds to the reference line h1 such that the reference line h1 fitted to the uppermost position of the moving body 100 is set to the reference horizontal position X1 of a distortion-corrected image. In addition, the instruction image generation part 13 may display the moving-body backward moving plane p2 whose one side corresponds to the base of the moving-body virtual vertical plane p. In this connection, the driving support device 1 may store the reference horizontal position X1, which corresponds to the uppermost position of the moving body 100 in a distortion-corrected image, in advance.

When the inclination of the moving body 100 is equal to or above the predetermined threshold value, the instruction image generation part 13 generates the second instruction image 5c corresponding to a distortion-corrected image solely including the moving-body backward moving plane p2 (S109). Subsequently, the output part 15 outputs the first instruction image 5b or the second instruction image 5c to the monitor 16 (S110).

According to the aforementioned processing, the first instruction image 5b to be output to the monitor 16 is generated such that the reference line h1 corresponding to the uppermost position of the moving body 100 may match the reference horizontal position X1 corresponding to the center position of the captured image in its vertical direction, and therefore it is possible for a driver to grasp the position relationship between an obstacle and the moving body when moving backwards.

According to the aforementioned processing, the first instruction image 5b to be output to the monitor 16 is generated using a distortion-corrected image which is produced by correcting distortions of a fisheye image. That is, the first instruction image 5b is generated based on a fisheye image, which is captured by the camera 2 including a fisheye lens having a wide angle of view in order to easily detect the position relationship between an obstacle and the moving body 100. For this reason, a driver may accurately grasp the position relationship between an obstacle and the moving body 100.

Next, a process for generating a distortion-corrected image (e.g. an image produced by correcting distortions of a fisheye image) with the driving support device 1 will be described in detail. In this connection, the following descriptions refer to one example of the process for generating a distortion-corrected image; hence, it is possible to use another process for generating a distortion-corrected image. In the following descriptions, “distortion correction(s)” of a fisheye image will be referred to as “normalization” (or “elimination of distortion”). In the normalization of a fisheye image, a viewpoint is set to a horizontal plane, and therefore it is necessary to set a plane serving as the basis of the horizontal plane (hereinafter, referred to “target plane”). As the target plane, it is possible to select a plane (or a ground plane) on which an longitudinally-elongated target object serving as a target subjected to normalization is grounded. When a target of normalization is a pedestrian, for example, it is possible to mention a road surface or a floor surface as the target plane. In addition, it is possible to define the target plane as a road surface having a vertical wall face or a slope. In this connection, the target plane may not be necessarily set to the actual horizontal plane for traveling the moving body (e.g. a vehicle) 100.

The following descriptions refer to a road surface as the target plane and a pedestrian as a subject of normalization (e.g. a captured subject reflected in a fisheye image), but the present exemplary embodiment should not be necessarily applied to limited targets such as a road surface and pedestrians.

The camera 2 is configured to capture images in real time so as to consecutively output captured images to the driving support device 1. As a concrete example of the camera 2, for example, it is possible to mention a video camera (or a cam-recorder) configured to output images having various digital formats such as images of the NTSC (National Television Standards Committee) format and images of the PAL (Phase Alternating Line) format.

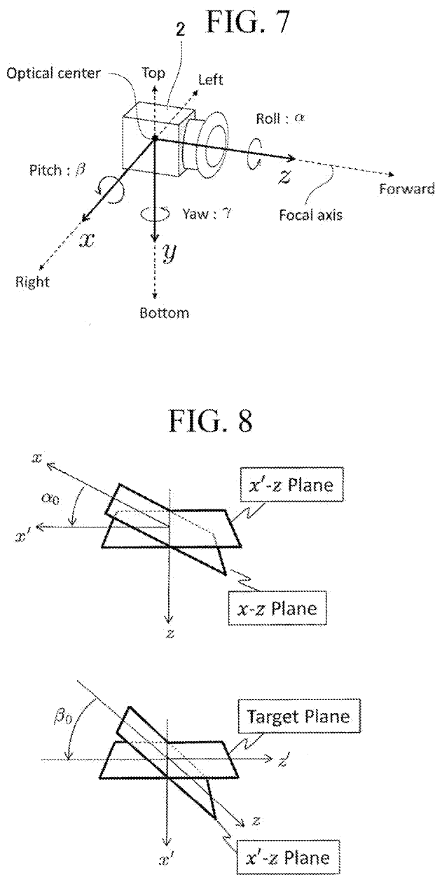

In FIG. 3, for example, the inclination sensor 107 is an angle senor. The information for measuring a relative vector between an optical-axis vector of the camera 2 and a vector parallel to the ground plane of a target object serving as a captured subject is provided here. As the information, it is possible to mention a roll angle (Roll) around an optical axis of the camera 2, a pitch angle (Pitch) around the optical axis, and a yaw angle (Yaw) around the optical axis (see FIG. 7).

Assuming a horizontal plane (or a ground) as a ground plane (or a target plane) of a target object, an angle sensor may set an initial value as a certain value (e.g. the angle-sensor information which will be described later) on the condition that the optical axis of the camera 2 is parallel to the horizontal direction while the inclination of the camera 2 is zero (i.e. a condition in which the horizontal direction of an image-capturing element is parallel to the horizontal plane), thus outputting a difference between the initial value and the angle-sensor information.

When the ground plane of a target object is not the horizontal plane (or a ground), the angle sensor may output a difference between the initial value and the angle-sensor information in consideration of a measured angle which was measured in advance with respect to the horizontal plane corresponding to the ground plane of a target object. Separate from the angle sensor, it is possible to install another sensor (or another angle sensor) configured to measure an angle relative to the ground plane of a target object. At this time, the angle sensor is configured to output a difference between the sensing data thereof and the sensing data of another sensor.

To generate a distortion-corrected image, the instruction image generation part 13 of the driving support device 1 is configured to carry out a fisheye-image acquisition process, a viewpoint-compensation-vector acquisition process, an image generation process, and a viewpoint-compensation-vector generation process. In the present exemplary embodiment, the fisheye-image acquisition process is configured to acquire an image of the camera 2 output to the driving support device 1, i.e. image data representative of a fisheye image. Upon acquiring the image data of a fisheye image, the instruction image generation part 13 may carry out a process for slicing an image area necessary to image data, a process for adjusting resolutions and sizes, a process for extracting odd-numbered fields (or even-numbered fields) from images of the NTSC format, and a process for adjusting an image format such as an image-quality improving process.

In the viewpoint-compensation-vector acquisition process, the instruction image generation part 13 is configured to acquire a viewpoint-compensated vector generated by the viewpoint-compensation-vector generation process. In the viewpoint-compensation-vector generation process, the instruction image generation part 13 is configured to generate a viewpoint-compensated vector as a relative vector between an optical-axis vector of the camera 2 and a vector parallel to the target plane. The relative vector may express rotation between two coordinates systems.

As a method for expressing rotation, in general, it is possible to mention quaternion, a Euler angle expression, and a roll-pitch-yaw angle expression, wherein the present exemplary embodiment may use any one of expression methods. The following descriptions refer to utilization of the roll-pitch-yaw angle (Roll-Pitch-Yaw) expression.

Coordinates and a rotation axis of the camera 2 will be described with reference to FIG. 7. FIG. 7 is a schematic diagram showing the definition of the coordinates system of the camera 2 connected to the driving support device 1 according to one exemplary embodiment of the present invention. In the present exemplary embodiment, the relative vector may include at least two-dimensional values including a roll angle (Roll) and a pitch angle (Pitch). The roll angle and the pitch angle are rotational angles necessary to fit the horizontal plane (or an x-z plane) including the optical axis of the camera 2 to the target plane.

The present exemplary embodiment may set a yaw angle (Yaw) as an arbitrary angle included in a range of a horizontal field of view of a fisheye image. The yaw angle is used to determine a center viewpoint in a horizontal direction with respect to an image which will be finally generated. Therefore, in order to maximally use the horizontal field of view in an original fisheye image, it is preferable to directly use an actual yaw angle with respect to the optical axis of the camera 2.

The expression format of a viewpoint-compensated vector will be described with reference to FIG. 8. FIG. 8 is a drawing used to explain a viewpoint-compensated vector described in the roll-pitch-yaw expression. It is possible to define the roll angle and the pitch angle as described below with reference to FIG. 8. In this connection, the roll angle and the pitch angle constituting a viewpoint-compensated vector will be in particular referred to as “relative roll angle” and “relative pitch angle”.

According to coordinates of the camera 2 as shown in FIG. 8, a rotation angle around a z-axis to an x′-z plane which is derived from an x-z plane with the same roll angle of the target plane will be defined as a relative roll angle α₀. A rotation angle around an x′-axis to a plane which is derived from the x′-z plane in parallel with the target plane will be defined as a relative pitch angle β₀.

Given an arbitrary yaw angle γ₀, for example, a viewpoint-compensated vector V will be expressed by Equation (1). When the arbitrary yaw angle γ₀ is defined by the optical axis of the camera 2, it is possible to establish “γ₀=0” in Equation (1).

[Equation 1]

V=(∝₀,β₀,γ₀)^{T} (1)

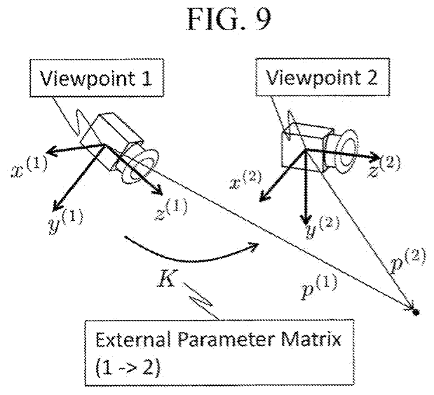

Using the viewpoint-compensated vector V, it is possible to achieve coordinates transformation between two viewpoints. FIG. 9 is a drawing used to explain coordinates transformation between two viewpoints to be carried out by the present exemplary embodiment. With reference to FIG. 9, in general, coordinates transformation at a certain point on a physical space can be expressed by Equation (2) using an external-parameter matrix K determinant from coordinates system 1 to coordinates system 2.

[Equation 2]

\tilde{p}⁽²⁾=K·\tilde{p}⁽¹⁾ (2)

In the above, “p tilde⁽ⁱ⁾” is a homogeneous expression of positional coordinates in a coordinates system i. The homogeneous expression is given by Equation (3).

[Equation 3]

\tilde{p}⁽ⁱ⁾=(x⁽ⁱ⁾,y⁽ⁱ⁾,z⁽ⁱ⁾,1)T (3)

In Equation (2), K can be generally expressed by Equation (4) using a rotation matrix R and a translation vector t.

$$\begin{matrix}[ Equation 4 ] & \\ K = ( \begin{matrix} & R & & t \\ 0 & 0 & 0 & 1\end{matrix} ) & ( 4 )\end{matrix}$$

In the roll-pitch-yaw expression, the rotation matrix R can be expressed by Equation (5) using the roll angle α, the pitch angle β, and the yaw angle γ.

$$\begin{matrix} [ Equation 5 ] & \\ R := {R}_{zxy} ( α , β , γ ) = {R}_{y} ( γ ) {R}_{x} ( β ) {R}_{z} ( α ) = [ \begin{matrix}cos γ & 0 & sin γ \\ 0 & 1 & 0 \\ - sin γ & 0 & cos γ\end{matrix} ] [ \begin{matrix}1 & 0 & 0 \\ 0 & cos β & - sin β \\ 0 & sin β & cos β\end{matrix} ] [ \begin{matrix}cos α & - sin α & 0 \\ sin α & cos α & 0 \\ 0 & 0 & 1\end{matrix} ] = [ \begin{matrix}\begin{matrix}cos γ cos α + \\ sin α sin β sin γ\end{matrix} & \begin{matrix}- cos γ sin α + \\ sin γ sin β cos α\end{matrix} & sin γ sin β \\ cos β sin α & cos β cos α & - sin β \\ \begin{matrix}sin γ cos α + \\ cos γ sin β sin α\end{matrix} & \begin{matrix}sin γ sin α + \\ cos γ sin β cos α\end{matrix} & cos γ cos β\end{matrix} ] & ( 5 )\end{matrix}$$

In the above, a viewpoint which is transformed by the viewpoint-compensated vector V defined in Equation (1) will be expressed as “central horizontalized viewpoint”, while a coordinates system admitting the existence of viewpoints will be expressed as a “central-horizontalized-viewpoint coordinate system”.

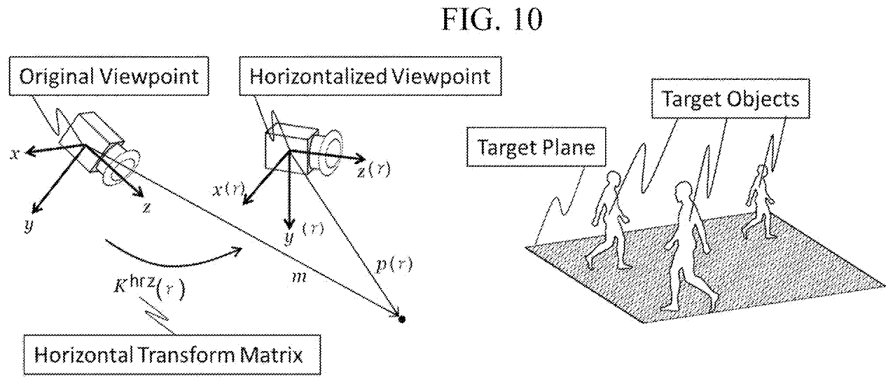

In addition, a set of viewpoints which are produced when rotating the central horizontalized viewpoint by an arbitrary yaw angle γ in parallel to the target plane will be expressed as “horizontalized viewpoints”, while a coordinate system for each viewpoint will be expressed as “horizontalized-viewpoint coordinates system”. FIG. 10 is a drawing used to explain a coordinates system in an original viewpoint and a horizontalized-viewpoint coordinates system.

The horizontalized-viewpoint coordinates system is produced via coordinates transformation using a viewpoint-compensated vector b (α₀,β₀) constituted of an arbitrary yaw angle γ as well as the roll angle and the pitch angle. The coordinates transformation to the horizontalized-viewpoint coordinates system can be expressed by Equation (6) using an external-parameter matrix K^{hrz}(γ) when (α,β)=(α₀,β₀) in Equation (4) and Equation (5).

[Equation 6]

\tilde{p}^{(γ)}=K(α₀,β₀,γ)·\tilde{m}=K^{hrz}(γ)·m̅ (6)

In the above, coordinates in the coordinates system in an original viewpoint can be expressed by Equation (7) while coordinates in the horizontalized-viewpoint coordinates system can be expressed by Equation (8).

[Equation 7]

\tilde{m}=(x,y,z,1)^{T} (7)

[Equation 8]

\tilde{p}^{(γ)}=(x^{(γ)},y^{(γ)},z^{(γ)},1)T

Assuming that the central horizontalized viewpoint shares an origin with the original viewpoint, it is possible to set the translation vector t to t=(0,0,0)^{T} in K^{hrz}(γ).

As described above, upon given the viewpoint-compensated vector V, it is possible to define the coordinates transformation K^{hrz}(γ) from the coordinates system of the original viewpoint to the horizontalized-viewpoint coordinates system. In the present exemplary embodiment, the instruction image generation part 13 is configured to generate a horizontal transform matrix K^{hrz}(γ) in the viewpoint-compensated vector generation process.

In the present exemplary embodiment, the instruction image generation part 13 is configured to set a viewpoint responsive to the number of all pixels in a horizontal direction of a normalized image. In addition, the instruction image generation part 13 is configured to correct distortions for each viewpoint, to slice a distortion-corrected image in a vertical direction, and to extract a slice image receiving a sight line incident from each viewpoint. Subsequently, the instruction image generation part 13 is configured to allocate a plurality of slice images in a predetermined order in a horizontal direction, thus generating a single normalized image.

Specifically, the instruction image generation part 13 determines a set of horizontalized viewpoints using the viewpoint-compensated vector V with respect to a fisheye image acquired in the fisheye-image acquisition process. Next, the instruction image generation part 13 divides a range of view in the horizontal direction into the arbitrary number of divisions so as to execute the distortion correction according to the perspective projection approximation in the horizontalized-viewpoint coordinates system for each horizontalized viewpoint among a set of horizontalized viewpoints (or a horizontalized-viewpoint string). Subsequently, the instruction image generation part 13 aligns image elements passing through the center of each viewpoint in the vertical direction in an order of a horizontalized-viewpoint string and then concatenates them together to generate a single composite image. Hereinafter, the processing of the instruction image generation part 13 will be described in detail.

<Distortion Correction According to Perspective Projection Approximation>

The distortion correction according to the perspective projection approximation will be concretely described below. The distortion correction according to the perspective projection approximation (i.e. the perspective-projection correction) can be generally obtained by the following method using the known camera model and the known already-corrected internal parameters in the camera model. In this connection, the distortion correction according to the perspective projection approximation can be realized by the known technology, which will be simply described for reference.

In the generally-known camera coordinates, it is possible to carry out modeling of relational expressions between a point p=(x,y,z)T on the real space and a certain point on a fisheye image by Equation (9) through Equation (11). In Equation (9), ρ′ can be expressed by Equation (12).

$$\begin{matrix}[ Equation 9 ] & \\ p = [ \begin{matrix}x \\ y \\ z\end{matrix} ] ∝ [ \begin{matrix}{u}^{′} \\ {υ}^{′} \\ f ( {ρ}^{′} )\end{matrix} ] & ( 9 ) \\ [ Equation 10 ] & \\ f ( {ρ}^{′} ) = {a}_{0} + {a}_{1} \cdot {ρ}^{′} + {a}_{2} \cdot {ρ}^{′2} + … + {a}_{N} \cdot {ρ}^{′ N} & ( 10 ) \\ [ Equation 11 ] & \\ [ \begin{matrix}{u}^{″} \\ {υ}^{″}\end{matrix} ] = [ \begin{matrix}c & d \\ e & 1\end{matrix} ] [ \begin{matrix}{u}^{′} \\ {υ}^{′}\end{matrix} ] + [ \begin{matrix}{u}^{″} \\ {υ}_{0}^{″}\end{matrix} ] & ( 11 ) \\ [ Equation 12 ] & \\ {ρ}^{′} = \sqrt{{u}^{′2} + {υ}^{′2}} & ( 12 )\end{matrix}$$

In Equation (9) and Equation (11), coordinates (u′,v′) indicate the coordinates of an ideal fisheye image (whose origin corresponds to the center) having no affine strains. In Equation (12), coordinates (u″, v″) indicate the actual coordinates of a fisheye image (whose origin corresponds to the upper-left position), while (u₀″,v₀″) indicate the actual center coordinates of a fisheye image. In Equation (11), a 2×2 square matrix is an affine transformation matrix.

In addition, parameters which can be obtained by approximating the coefficients of Equation (10) up to a fourth-degree order are internal parameters of a camera which are determined according to distortions of a fisheye lens and a deviation of the position relationship between an optical axis of a fisheye lens and an image-capturing element. In this connection, Equation (13) shows internal parameters.

[Equation 13]

[a₀,a₁,a₂,a₃,a₄,c,d,e, [symbol] ₀″, [symbol] ₀″] (13)

The parameters shown in Equation (13) can be obtained in advance according to the calibration method disclosed in Non-Patent Document 1.

Upon setting an image plane (z=z_{d}) perpendicular to a z-axis of the coordinates system, it is possible to obtain the corresponding fisheye coordinates (u″,v″) using relational expressions, i.e. Equation (9) through Equation (11), with respect to the image coordinates (u_{d},v_{d}) defined on an image plane (z=z_{d}). Therefore, it is possible to generate a distortion-corrected image according to the perspective-projection approximation (hereinafter, referred to as a “perspective-projection-corrected image”) by replacing the pixel values of the image coordinates (u_{d},v_{d}) with the pixel values of the fisheye-image coordinates (u″,v″) with reference to the pixel values of the fisheye-image coordinates (u″,v″) corresponding to the image coordinates (u_{d},v_{d}).

In this connection, the pixel values of the fisheye-image coordinates can be expressed as luminance values of a single channel in a monochrome image or luminance values of three channels of R, B, Gin a color image. In addition, a value of z=zd indicates a distance from a focal point on a projected plane, which is a decisive parameter for determining the scale of a perspective-projection-corrected image.

<Effect of Distortion Correction According to Perspective Projection Approximation>

Since a horizontal transform matrix is given by a viewpoint-compensated vector, it is possible to define a perspective-projection image plane in an arbitrary horizontalized viewpoint. As a result, the instruction image generation part 13 is configured to generate a perspective-projection-corrected image for each horizontalized viewpoint using the aforementioned method.

It is known that the linearity can be restored in a perspective-projection-corrected image, but a scale distortion of a captured subject will be increased due to a projection distortion. Therefore, the instruction image generation part 13 is configured to solely extract center strings of a perspective-projection-corrected image generated for each viewpoint and to concatenate center strings in the horizontal direction. Accordingly, it is possible to generate a single continuous image with suppressing its scale distortion in the horizontal direction and with maintaining the linearity in the vertical direction. Thus, it is possible to elaborate a single normalized image with a small geometric distortion and with a consistent scale for all longitudinally-elongated three-dimensional objects which may exist on the target plane used for capturing an original fisheye image.

<Concrete Process of Image Generation Part>

A concrete example of the processing of the instruction image generation part 13 will be described below. An image string passing through the center of a perspective-projection-corrected image (I_{P}), which is generated from an original fisheye image (I_{F}) for each horizontalized-viewpoint coordinates system, will be referred to as a “normalized slice image (I_{S})”. In addition, a lastly-output image will be referred to as a “normalized panorama image (I_{H})”. In the present exemplary embodiment, the instruction image generation part 13 may realize a series of functions to generate a normalized panorama image.

First, the instruction image generation part 13 defines the size (width, height)=(W₀,H₀) of a lastly-output image. Next, the instruction image generation part 13 defines a horizontalized viewpoint string used for elaboration of a normalized panorama image. Since the roll angle and the pitch angle in a viewpoint have been determined using the viewpoint-compensated vector V, it is necessary to define a set Φ of yaw angles ϕᵢ. In the following descriptions, a horizontalized viewpoint having a yaw angle ϕᵢ may be expressed as a horizontalized viewpoint ϕᵢ. In this connection, the set Φ has the same number of series as the number of lateral pixels of an image and can be expressed by Equation (14).

[Equation 14]

Φ={ϕᵢ|ϕᵢ>ϕᵢ₊₁,i=0, . . . ,Wₒ−1} (14)

The set Φ can be arbitrarily determined within a horizontal field of view of an original fisheye image. The upper limit and the lower limit of the set Φ may determine a horizontal field of view (FOV_H) to be drawn by a normalized panorama image. To secure the horizontal field of view FOV_H=185°, for example, the range of a horizontalized viewpoint string can be defined as the range shown by Equation (15).

[Equation 15]

[ϕₘᵢₙ,ϕₘₐₓ]=[−92.5°,92.5°] (15)

In general, fisheye images will be subjected to modeling as mapping in one direction of point groups projected on a spherical surface model in real space. At this time, it is possible to assume that the center of a sphere may match the center of optics. Since the origin for each horizontalized viewpoint coordinates system is fitted to the center of optics, the set Φ can be defined as equally-segmented resolutions as shown in Equation (16). In this connection, Equation (16) sets i=0, . . . , W₀−1.

$$\begin{matrix}[ Equation 16 ] & \\ Φ = \{ {ϕ}_{i} = {ϕ}_{max} - \frac{{ϕ}_{max} - {ϕ}_{min}}{{W}_{o} - 1} \cdot i \} & ( 16 )\end{matrix}$$

Points for each horizontalized viewpoint coordinates system (Equation (17)) can be produced by Equation (18) using the horizontalized transform matrix K^{hrz}(γ) since a point-m tilde in an original camera coordinates system can be expressed as “(x,y,z,1)^{T}”.

[Equation 17]

O^{(ϕ}^{ᵢ}⁾ (17)

[Equation 18]

\tilde{p}^{(ϕ}^{ᵢ}⁾=K^{hrz}(ϕᵢ)·\tilde{m} (18)

Upon setting an image plane (Equation (20)) perpendicular to a z-axis (Equation (19)) of the horizontalized viewpoint coordinates system (Equation (17)), as described above, it is possible to produce the association relationship with the pixel (u″,v″) on an original fisheye image according to image coordinates defined on the image plane (Equation (21)). Herein, a perspective-projection-corrected image is an image which is produced by projecting pixel points of a fisheye image to image coordinates (Equation (21)). In addition, the constant of Equation (20) represents a distance from a projected plane to a focal point, which is a parameter for determining the scale of a perspective-projection-corrected image.

[Equation 19]

z^{(ϕ}^{ᵢ}⁾ (19)

[Equation 20]

z^{(ϕ}^{ᵢ}⁾=z_{d}^{(ϕ}^{ᵢ}⁾=const. (20)

[Equation 21]

( [symbol] _{d}^{(ϕ}^{ᵢ}⁾, [symbol] _{d}^{(ϕ}^{ᵢ}⁾) (21)

The normalized slice image (I_{S}) is an image string passing through the center of the perspective-projection-corrected image (I_{P}) in the vertical direction. The normalized slice image (I_{S}) is a special variation of the perspective-projection-corrected image (I_{P}) which is generated on the condition that the lateral size of a projected image is set to one pixel when projecting the perspective-projection-corrected image (I_{P}) to a perspective-projection image plane. In this connection, it is unnecessary to carry out a slicing process after generating another perspective-projection-corrected image (I_{P}) having a larger lateral size for the purpose of generating the normalized slice image (I_{S}).

Normally, a scale parameter (Equation (23)) for generating the normalized slice image (Equation (22)) for each horizontalized viewpoint coordinates system (Equation (17)) can be defined by the same value for each horizontalized viewpoint coordinates system, and therefore set the scale parameter in consideration of an aspect ratio of the finally-normalized panorama image. As the scale parameter, it is possible to directly set its value, but it is possible to indirectly set its value using other parameters, which will be described later.

[Equation 22]

I_{S}^{(ϕ}^{ᵢ}⁾ (22)

[Equation 23]

Z_{d}={z_{d}^{(ϕ}^{ᵢ}⁾} (23)

In the present exemplary embodiment, the normalized panorama image (I_{H}) is defined as a composite image which is produced by aligning normalized slice images (Equation (22)) for each horizontalized viewpoint coordinates system (Equation (17)) from the left in an order of the set Φ of yaw angles ϕᵢ in a horizontalized viewpoint. Every element of the normalized panorama image (I_{H}) can be defined by Equation (24). In this connection, Equation (24) includes image coordinates in parentheses, where i=0, 1, . . . , W₀−1 and where j=0, 1, . . . , H₀−1.

[Equation 24]

{I_{H}(i,j)}={I_{S}^{(ϕ}^{ᵢ}⁾(0,j)} (24)

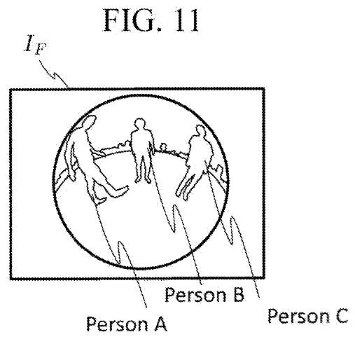

Next, an example of a fisheye image and its image generation process will be described with reference to FIGS. 11-13. FIG. 11 is a schematic diagram showing an example of the fisheye image (IF) to be processed according to the present exemplary embodiment. In FIG. 11, the fisheye image may include three persons (i.e. Person A, Person B, and Person C) whose images are captured in a downward viewpoint using the ground as a target plane.

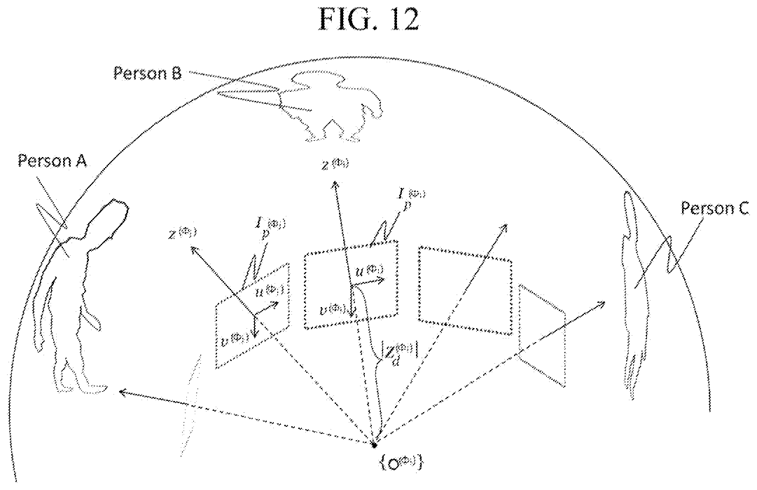

The driving support device 1 carries out its processing with respect to the fisheye image shown in FIG. 11. As shown in FIG. 12, a perspective-projection image plane will be defined in each horizontalized viewpoint coordinates system (Equation (17)). FIG. 12 is a drawing showing an example of the horizontalized viewpoint coordinates system to be defined by the present exemplary embodiment. In addition, coordinates on a perspective-projection image plane are expressed by Equation (21). Accordingly, a perspective-projection-corrected image (I_{P}: Equation (25)) having an arbitrary image size and including the normalized slice image (I_{S}) will be generated on the perspective-projection image plane.

[Equation 25]

I_{P}^{(ϕ}^{ᵢ}⁾ (25)

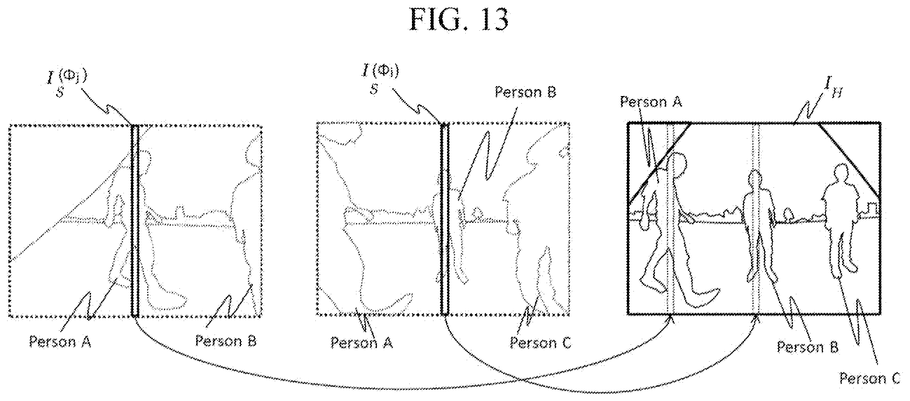

FIG. 13 shows two perspective-projection-corrected images having different horizontalized viewpoints and a normalized panorama image which can be obtained from those perspective-projection-corrected images.

Specifically, the left-side image of FIG. 13 is formed using the perspective-projection-corrected image (Equation (27)) and the normalized slice image (Equation (28)) to be produced in the horizontalized viewpoint (Equation (26)). The center image of FIG. 13 is formed using the perspective-projection-corrected image (Equation (30)) and the normalized slice image (Equation (31)) to be produced in the horizontalized viewpoint (Equation (29)).

[Equation 26]

O^{(ϕ}^{ᵢ}⁾ (26)

[Equation 27]

I_{P}^{(ϕ}^{ᵢ}⁾ (27)

[Equation 28]

I_{S}^{(ϕ}^{ᵢ}⁾ (28)

[Equation 29]

O^{(ϕ}^{ⱼ}⁾ (29)

[Equation 30]

I_{P}^{(ϕ}^{ⱼ}⁾ (30)

[Equation 31]

I_{S}^{(ϕ}^{ⱼ}⁾ (31)

The right-side image of FIG. 13 is an example of the normalized panorama image (I_{H}) which is produced using all the normalized slice images in the predefined horizontalized viewpoint string (Equation (32)). As shown in FIG. 13, the normalized panorama image (I_{H}) can be produced by elaborating elements, i.e. all the normalized slice images including normalized slice images (Equation (28)) and (Equation (31)).

[Equation 32]

Φ={ϕᵢ} (32)

<Indirect Determination Process of Scale Parameter>

To implement distortion corrections according to a perspective projection approximation for each viewpoint, the instruction image generation part 13 is configured to determine the distance against the origin of a projected plane in the horizontalized viewpoint coordinates system based on the size, the range of the field of angle in the horizontal direction, and the aspect ratio of the normalized panorama image.

As described above, the image scale used to generate the perspective-projection-corrected image and the normalized slice image may depend on the distance |z_{d}| of a projected plane for each coordinate. For the practical use, it is convenient to indirectly determine the image scale to meet constraint conditions such as the range of the field of view and the image size rather than directly designating the image scale.

The following descriptions refer to a method how to determine the scale by designating the range of the field of view and an aspect ratio of an image. The following descriptions refer to (W₀, H₀) as (width, height) representing the size of the normalized panorama image, Aₓ as the field of view in the horizontal direction for projection on the normalized panorama image, and A_{y} as the field of view in the vertical direction. In addition, Equation (33) expresses a longitudinal/lateral (angle/pixel) ratio of the normalized panorama image. In Equation (33), the upper-limit value of A_{y} is set to 180° (Equation (34)).

$$\begin{matrix}[ Equation 33 ] & \\ μ = \frac{{A}_{Y} / {H}_{o}}{{A}_{X} / {W}_{o}} & ( 33 ) \\ [ Equation 34 ] & \\ {A}_{{Y}_{max}} < 180 ° & ( 34 )\end{matrix}$$

In addition, it is possible to set the scale |z_{d}| according to steps (a), (b).

Step (a): (|z_{d}|, A_{y}) is determined by Equations (35), (36) using a constraint condition (W₀, H₀, Aₓ, μ).

$$\begin{matrix}[ Equation 35 ] & \\ {A}_{Y} = {A}_{X} \times \frac{{H}_{o}}{{W}_{o}} \times μ & ( 35 ) \\ [ Equation 36 ] & \\ \vert {z}_{d} \vert = \frac{{H}_{o} / 2}{tan ( {A}_{Y} / 2 )} & ( 36 )\end{matrix}$$

Step (b): (Ax, Ay, |z_{d}|) is replaced with Equation (41) via recalculation using Equation (38) through Equation (40) upon establishing Equation (37).

$$\begin{matrix}[ Equation 37 ] & \\ {A}_{Y} \geq {A}_{{Y}_{max}} & ( 37 ) \\ [ Equation 38 ] & \\ {A}_{Y}^{*} = {A}_{{Y}_{max}} & ( 38 ) \\ [ Equation 39 ] & \\ {A}_{X} = {A}_{Y}^{*} \times \frac{{W}_{o}}{{H}_{o}} \times \frac{1}{μ} & ( 39 ) \\ [ Equation 40 ] & \\ {\vert {z}_{d} \vert}^{*} = \frac{{H}_{o} / 2}{tan ( {A}_{Y}^{*} / 2 )} & ( 40 ) \\ [ Equation 41 ] & \\ ( {A}_{X}^{*} , {A}_{Y}^{*} , {\vert {z}_{d} \vert}^{*} ) & ( 41 )\end{matrix}$$

<High-Speed Processing Via Look-Up Table (LUT) Process>

In the present exemplary embodiment, the instruction image generation part 13 is configured to carry out the viewpoint-compensation-vector acquisition process to acquire as a viewpoint-compensated vector a table describing an association between coordinates of a fisheye image and coordinates of an image capturing a target object in a direction parallel to the ground plane.

Specifically, in the present exemplary embodiment using a fixed viewpoint-compensated vector which is determined in advance, the instruction image generation part 13 may carry out the viewpoint-compensation-vector generation process to generate in advance a reference table describing an association between coordinates (u_{H},v_{H}) of the normalized panorama image and its corresponding coordinates (u″,v″) of an original fisheye image. In this case, the actual process for generating the normalized panorama image corresponding to input image series will be replaced with an LUT process for generating the normalized panorama image with reference to the lookup table (LUT).

For example, it is possible to achieve high-speed processing for generating normalized panorama images from fisheye images by executing the LUT process for sequentially generating normalized panorama images with respect to input image series online after generating a lookup table offline. In this aspect, it is possible to construct an image processing system suitable to the usage requiring implementation to a processor which may operate using a clock having low operating frequency.

As a concrete method for generating a lookup table, it is possible to provide the following method. First, there are provided two-channel matrixes (referred to as index matrixes) each having the width and the height equivalent to the size (Wᵢₙ,Hᵢₙ) of an original fisheye image. Subsequently, the corresponding coordinate values of (u″) are set to columns of an X-index matrix (X_{ind}) as a first-channel matrix while the corresponding coordinate values of (v″) are set to rows of a Y-index matrix (Y_{ind}) as a second-channel matrix.

That is, index matrixes are defined by Equations (42), (43) on the condition of Equation (44).

[Equation 42]

{X_{ind}(i,j)= [symbol] ″(i)|i=0, . . . ,Wᵢₙ−1,j=0, . . . ,Hᵢₙ−1} (42)

[Equation 43]

{Y_{ind}(i,j)= [symbol] ″(j)|i=0, . . . ,Wᵢₙ−1,j=0, . . . ,Hᵢₙ−1} (43)

[Equation 44]

{ [symbol] ″(i)=i|i=0, . . . ,Wᵢₙ−1},{ [symbol] ″(j)|j=0, . . . ,Hᵢₙ−1} (44)

The instruction image generation part 13 is configured to execute generating a normalized panorama image upon inputting (X_{ind}) and (Y_{ind}), and then the instruction image generation part 13 may carry out the viewpoint-compensation-vector generation process to generate a LUT map (X_{LUT}), (Y_{LUT}) from the normalized panorama image. The LUT map is configured to store the corresponding values of coordinates (u″), (v″) of an original fisheye image at coordinates (u_{H},v_{H}) of (X_{LUT}), (Y_{LUT}). Accordingly, it is possible to obtain a one-to-one correspondence relationship between the coordinates (u_{H},v_{H}) and the coordinates (u″,v″) of a fisheye image.

For example, the LUT map which is generated as described above can be saved as a lookup table file in the text file format for enumerating every one row of the one-to-one correspondence relationship (Equation (45)).

[Equation 45]

[ [symbol] _{H}, [symbol] _{H}, [symbol] ″, [symbol] ″] (45)

In the LUT process, the instruction image generation part 13 firstly loads the lookup table file which was generated in advance. Subsequently, the instruction image generation part 13 successively refers to the pixel values of a fisheye image corresponding to the coordinates of a normalized panorama image according to the information associating the coordinates (u″,v″) of an original fisheye image and the coordinates (uH,vH) of a normalized panorama image described on the lookup table, thus generating the normalized panorama image.

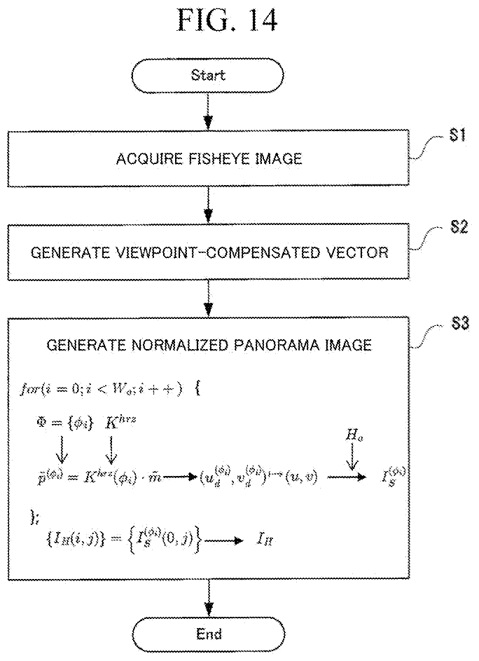

Next, the operation of the driving support device 1 according to the present exemplary embodiment will be described with reference to FIG. 14. FIG. 14 is a flowchart showing an image generation process of the present exemplary embodiment (steps S1 through S3).

As shown in FIG. 14, the instruction image generation part 13 carries out the fisheye-image acquisition process to acquire a fisheye image from the camera 2 (S1). Next, the instruction image generation part 13 carries out the viewpoint-compensation-vector acquisition process to acquire a viewpoint-compensated vector (S2).

Next, the instruction image generation part 13 generates a normalized panorama image (i.e. a distortion-corrected image) using the fisheye image acquired in step S1 and the viewpoint-compensated vector acquired in step S2 (S3).

Specifically, the instruction image generation part 13 determines a set of horizontalized viewpoints using the viewpoint-compensated vector against the fisheye image captured by the camera 2. Next, the instruction image generation part 13 divides the range of the field of view in the horizontal direction into an arbitrary number of divisions so as to execute distortion corrections according to the perspective projection approximation in the horizontalized viewpoint coordinates system for each horizontalized viewpoint. Subsequently, the instruction image generation part 13 aligns image elements passing through the center of each viewpoint in the vertical direction in an order of the horizontalized viewpoint string in the horizontal direction and concatenates the aligned image elements to generate a single normalized panorama image (or a distortion-corrected image). Subsequently, the instruction image generation part 13 generates the first instruction image 5b or the second instruction image 5c using the normalized panorama image (or the distortion-corrected image).

By executing steps S1-S3, it is possible to generate a single normalized panorama image. The present exemplary embodiment is designed to repeatedly execute a series of steps S1-S3 in a predetermined interval of time, it is possible to consecutively output the first instruction image 5b or the second instruction image 5c using the normalized panorama image (or the distortion-corrected image).

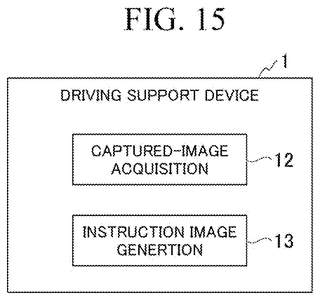

FIG. 15 is a drawing showing the minimum configuration of the driving support device 1. The driving support device 1 includes at least the captured-image acquisition part 12 and the instruction image generation part 13. The captured-image acquisition part 12 is configured to acquire a captured image of the camera 2 mounted on the moving body 100. The instruction image generation part 13 is configured to generate an instruction image based on the captured image such that the position of a predetermined portion of the moving body 100 can be fitted to the reference position of the captured image.

The aforementioned driving support device 1 has a computer system. For this reason, programs showing the foregoing processes and steps have been stored on computer-readable storage media, and therefore a computer may load and execute programs to implement the foregoing processes. Herein, computer-readable storage media refer to magnetic disks, magneto-optical disks, CD-ROM, DVD-ROM, semiconductor memory or the like. In addition, it is possible to deliver computer programs to a computer through communication lines, wherein the computer may execute computer programs.

The foregoing programs may achieve part of the foregoing functions. Moreover, the foregoing programs may be differential files (or differential programs) which can be combined with pre-recorded programs of a computer system to realize the foregoing functions.

The foregoing exemplary embodiment is described such that a camera is disposed at the rear side of a moving body which may move backwards. However, this is not a restriction. For example, the present invention can be applied to another configuration in which a camera is disposed at the foreside or lateral side(s) of a moving body which may move forwards or laterally. When a camera is disposed at the foreside of a moving body (or a vehicle) which may pass through a tunnel having a height limitation, it is possible for a driver to more accurately grasp the position relationship between the height of a tunnel entrance and the height of a moving body.

Lastly, the present embodiment is not necessarily limited to the foregoing exemplary embodiment, and therefore the present invention may include various modifications and design changes within the scope of the invention as defined by the appended claims. For example, an imaging device is not necessarily mounted on a moving body (or a vehicle) since an imaging device can be attached to an entrance of a gate which a moving body may pass through or an entrance of a warehouse, wherein captured images will be transmitted to a terminal mounted on a moving body so that an operator can grasp the position relationship between a moving body and an obstacle. Alternatively, it is possible to capture an image covering a moving body and an obstacle using an imaging device disposed in a moving range of a moving body so that an operation can remotely operate a moving body by watching the captured image.

The present application claims the benefit of priority on Japanese Patent Application No. 2018-140768 filed on Jul. 26, 2018, the subject matter of which is hereby incorporated herein by reference.

### INDUSTRIAL APPLICABILITY

The present exemplary embodiment is designed to correct an image captured by an imaging device mounted on a moving body and to present an operator of a moving body with the visual information such that the operator can grasp the position relationship with an obstacle which may exist in the rear side of a moving body. The moving body is not necessarily limited to a vehicle, and therefore a moving body may be a drone or an object which can be remotely operated by an operator. In this case, the operation can remotely operate a drone or an object by watching an image transmitted from an imaging device mounted on a drone or an object.

### REFERENCE SIGNS LIST

1 driving support device
2 camera (imaging device)
5a fisheye image
5b first instruction image
5c second instruction image
11 control part
12 captured-image acquisition part
13 instruction image generation part
14 inclination determination part
15 output part
101 CPU
102 ROM
103 RAM
104 storage unit
105 communication module
106 monitor
107 inclination sensor (angle sensor)

What is claimed is:

1. A driving support device comprising:
a captured-image acquisition part configured to acquire a captured image from an imaging device configured to capture an image in surrounding of a moving body; and
an instruction image generation part configured to generate an instruction image based on the captured image such that a position of a predetermined portion of the moving body is fitted to a position of a reference line in the captured image.

2. The driving support device according to claim 1, wherein the predetermined portion of the moving body corresponds to an uppermost position of the moving body, and wherein the instruction image generation part is configured to generate the instruction image such that the uppermost position of the moving body is fitted to the position of the reference line in the captured image.

3. The driving support device according to claim 2, wherein the imaging device is attached to an upper portion of the moving body in order to capture an image of an imaging range in a rear side of the moving body, and wherein the instruction image generation part is configured to generate the instruction image such that the reference line indicating the uppermost position of the moving body is fitted to a reference horizontal position of the captured image.

4. The driving support device according to claim 3, wherein the instruction image generation part is configured to display the reference line in the instruction image.

5. The driving support device according to claim 4, further comprising an inclination determination part configured to determine an inclination of the moving body based on inclination information from a sensor configured to detect the inclination of the moving body, wherein when the inclination of the moving body is equal to or above a predetermined inclination, the instruction image generation part is configured not to display the reference line in the instruction image.

6. The driving support device according to claim 1, wherein the instruction image generation part is configured to display traveling prediction lines extended by a predetermined distance backwardly along opposite sides of the moving body in the captured image, and wherein the instruction image generation part is configured to display a moving-body virtual vertical plane configured of a line connected between distal points of the traveling prediction lines extended by the predetermined distance backwardly from the moving body, vertical lines originated from the traveling prediction lines, and the reference line indicating the uppermost position of the moving body in the instruction image.

7. The driving support device according to claim 1, wherein the instruction image generation part is configured to display in the instruction image a moving-body backward moving plane configured of traveling prediction lines extended by a predetermined distance backwardly along opposite sides of the moving body in the captured image and a line connected between distal points of the traveling prediction lines extended by the predetermined position backwardly from the moving body.

8. A driving support method comprising:
acquiring a captured image from an imaging device configured to capture an image in surrounding of a moving body; and
generating an instruction image based on the captured image such that a position of a predetermined portion of the moving body is fitted to a position of a reference line in the captured image.

9. A non-transitory computer-readable storage medium having a stored program causing a computer to implement the steps of:
acquiring a captured image from an imaging device configured to capture an image in surrounding of a moving body; and
generating an instruction image based on the captured image such that a position of a predetermined portion of the moving body is fitted to a position of a reference line in the captured image.
